(19) United States
(12) Patent Application Publication
(10) Pub. No.: US 2017/0331306 A1
(43) Pub. Date: Nov. 16, 2017

(54) ELECTRONIC DEVICE HAVING WIRELESS CHARGING DEVICE

(71) Applicant: Szu Chi LO, Nantou City (TW)

(72) Inventor: Szu Chi LO, Nantou City (TW)

(21) Appl. No.: 15/152,186

(22) Filed: May 11, 2016

(51) Int. Cl. H02J 7/00; H02J 7/02

(52) U.S. Cl. CPC H02J 7/0042; H02J 7/025

(57) ABSTRACT

The present invention relates to an electronic device having a wireless charging device, and includes an electronic device, an electromagnetic power bank, and an electromagnetic charger. The electronic device has an electromagnetic coil and a battery therein. The electromagnetic power bank has first and second electromagnetic coils and a battery therein. The electromagnetic charger has an electromagnetic coil therein. Through this device, the electromagnetic charger can be connected with a power source for charging the electromagnetic power bank, and the electromagnetic power bank is further to charge the electronic device. The electronic device and the electromagnetic power bank can be assembled together for use, so that it is convenient to complete a charge and the quantity of electricity can be increased to extend the time of use.

### BACKGROUND OF THE INVENTION

### 1. Field of the Invention

The present invention relates to an electronic device having a wireless charging device, and more particularly to an electronic device which can be charged conveniently to increase its electricity so as to extend the time of use.

### 2. Description of the Prior Art

A conventional electronic device can be charged in different ways, namely, a wired way and a wireless way. In a wired way, the electronic device is provided with a battery therein. A charging device is connected with a power source and further connected with the electronic device through a wire for charging the electronic device. A power bank is also connected with a wire. The charging is done in a wired way. It is inconvenient for use. The power bank cannot be combined with the electronic device, so it is not convenient to be taken along. In a wireless way, the electronic device has an electromagnetic coil and a battery therein. An electromagnetic charger is connected with a power source. The electromagnetic charger corresponds to the electromagnetic coil of the electronic device, enabling the electromagnetic coil of the electronic device to generate an electromagnetic field for charging the battery. Although the wireless charging is convenient, the electronic device is charged only by the electromagnetic charger. The electronic device doesn't have a power bank for charging. There is no electromagnetic power bank on the market, so the electronic device is unable to have more electricity. Accordingly, the inventor of the present invention has devoted himself based on his many years of practical experiences to solve these problems.

### SUMMARY OF THE INVENTION

The present invention is to overcome the shortcomings of the prior art. The primary object of the present invention is to provide an electronic device having a wireless charging device. The present invention comprises an electronic device, an electromagnetic power bank, and an electromagnetic charger. The electronic device has an electromagnetic coil and a battery therein. The electromagnetic power bank has first and second electromagnetic coils and a battery therein. The electromagnetic charger has an electromagnetic coil and can be connected with a power source.

Through the aforesaid device, the electromagnetic charger can directly charge the electromagnetic power bank. The electronic device and the electromagnetic power bank can be assembled together to become one-piece, such that the electromagnetic power bank can supply power to the electronic device and the electromagnetic charger is to charge the electromagnetic power bank. It is convenient for charging.

The electricity of the electronic device can be increased to extend the time of use.

### BRIEF DESCRIPTION OF THE DRAWINGS

FIG. 1 is an exploded view of the present invention;

FIG. 2 is a schematic view showing the interior structure of the electromagnetic power bank of the present invention;

FIG. 3 is a schematic view showing the interior structure of the electromagnetic charger of the present invention;

FIG. 4 is a schematic view of the present invention, showing that the electromagnetic charger is to charge the electromagnetic power bank;

FIG. 5 is a perspective view of the present invention in a charging state;

FIG. 6 is a perspective view showing that the electronic device and the electromagnetic power bank of the present invention are assembled to supply power;

FIG. 7 is a perspective view of the present invention, showing that the electromagnetic charger is to charge the electromagnetic power bank; and

FIG. 8 is a perspective view of the present invention, showing that the electromagnetic charger is to charge two electromagnetic power banks simultaneously.

### DETAILED DESCRIPTION OF THE PREFERRED EMBODIMENTS

Embodiments of the present invention will now be described, by way of example only, with reference to the accompanying drawings.

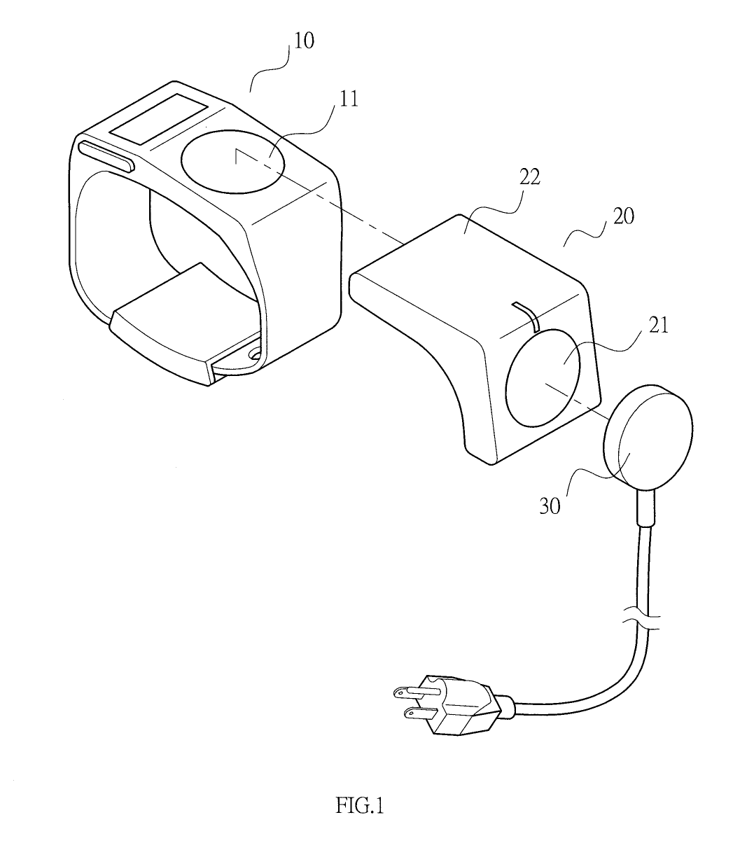

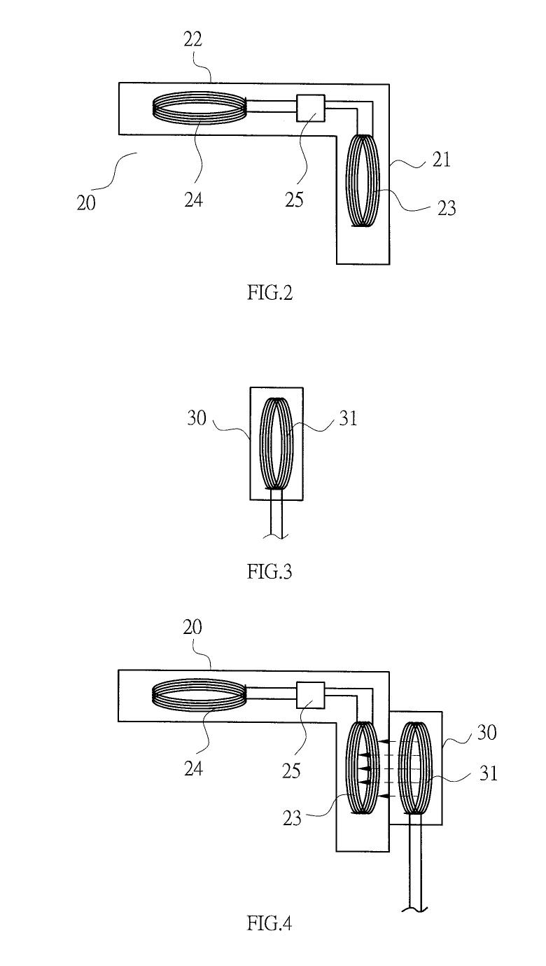

As shown in FIG. 1, FIG. 2, FIG. 3 and FIG. 4, the present invention comprises an electronic device 10, an electromagnetic power bank 20, and an electromagnetic charger 30. The electronic device 10 has a charging area 11. The charging area is provided with an electromagnetic coil and a battery therein. The electromagnetic power bank 20 has a charging area 21, a discharging area 22, and a battery 25. The charging area 21 is provided with a first electromagnetic coil 23 therein. The discharging area 22 is provided with a second electromagnetic coil 24 therein. The first electromagnetic coil 23 and the second electromagnetic coil 24 are connected with the battery 25, respectively. The electromagnetic charger 30 has an electromagnetic coil 31, and can be connected with a power source.

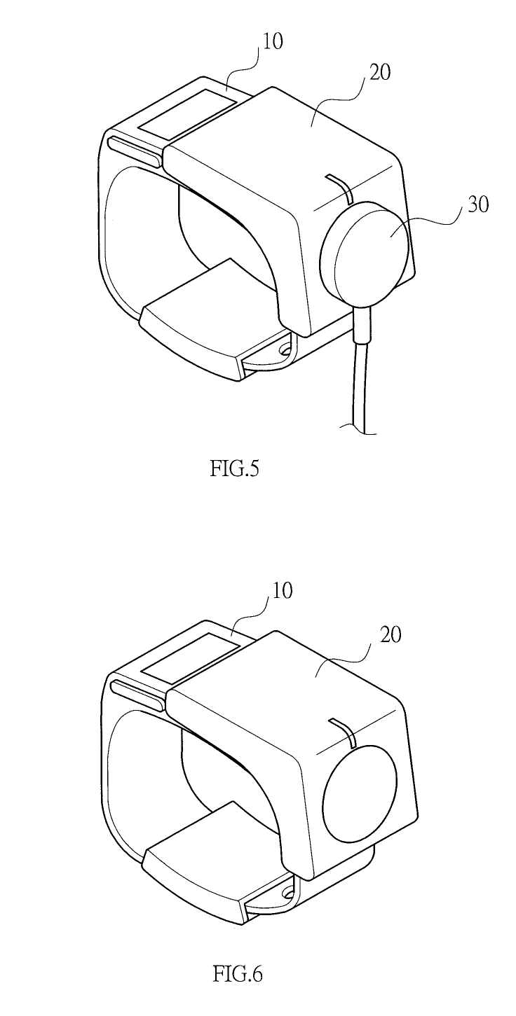

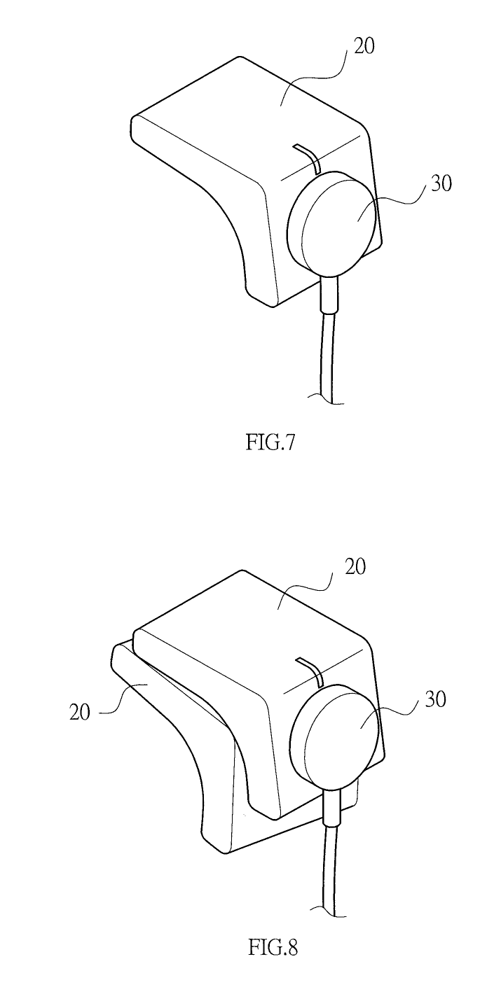

According to the aforesaid device, the user can elect the following charge or power supply way. The first way, as shown in FIG. 2, FIG. 4, FIG. 5, the discharging area 22 of the electromagnetic power bank 20 is attached to the charging area 11 of the electronic device 10. The electromagnetic charger 30 is attached to the charging area 21 of the electromagnetic power bank 20. The second electromagnetic coil 24 of the electromagnetic power bank 20 corresponds to the electromagnetic coil of the electronic device 10. The electromagnetic coil 31 of the electromagnetic charger 30 corresponds to the first electromagnetic coil 23 of the electromagnetic power bank 20. The corresponding electromagnetic coils generate an electromagnetic field to get electromagnetic induction. The electromagnetic coil 31 of the electromagnetic charger 30 enables the first electromagnetic coil 23 to generate electricity for charging the battery 25. The electricity of the battery 25 enables the second electromagnetic coil 24 to generate an electromagnetic field. The electromagnetic coil of the electronic device generates electricity to charge the battery of the electronic device. The second way, as shown in FIG. 6, the electromagnetic power bank 20 is attached to the electronic device 10. The electromagnetic coil of the electronic device 10 and the second electromagnetic coil 24 of the electromagnetic power bank 20 generate an electromagnetic field to induct each other and charge. The electronic device 10 has the electromagnetic power bank 20 to increase the quantity of electricity and to extend the time of use. The third way, as shown in FIG. 7, the electromagnetic charger 30 is to charge the electromagnetic power bank 20. The fourth way, as shown in FIG. 8, the electromagnetic charger 30 is to charge the electromagnetic power bank 20, and the electromagnetic power bank 20 is to charge another the electromagnetic power bank 20.

As the aforesaid, the present invention is very convenient to complete a charge. The electronic device 10 can have different choices for a charge or a power supply. It can be used conveniently.

Although particular embodiments of the present invention have been described in detail for purposes of illustration, various modifications and enhancements may be made without departing from the spirit and scope of the present invention.

Accordingly, the present invention is not to be limited except as by the appended claims.

What is claimed is:

1. An electronic device having a wireless charging device, comprises the electronic device, an electromagnetic power bank, and an electromagnetic charger, the electronic device having a charging area, the charging area being provided with an electromagnetic coil and a battery therein, the electromagnetic power bank having a charging area, a discharging area, and a battery, the charging area of the electromagnetic power bank being provided with a first electromagnetic coil therein, the discharging area of the electromagnetic power bank being provided with a second electromagnetic coil therein, the first electromagnetic coil and the second electromagnetic coil being respectively connected with the battery of the electromagnetic power bank, the electromagnetic charger having an electromagnetic coil therein and being able be to be connected with a power source; wherein the electromagnetic charger is able to charge the electromagnetic power bank by the action of an electromagnetic field and the electromagnetic power bank is able to charge the electronic device by the action of an electromagnetic field.
